(19) United States
(12) Patent Application Publication
(10) Pub. No.: US 2007/0153648 A1
(43) Pub. Date: Jul. 5, 2007

(54) Information storage medium storing different read power information

(76) Inventors: Kyung-Geun Lee, Seongnam-si (KR); Joo-Ho Kim, Yongin-si (KR); In-Oh Hwang, Seongnam-si (KR); Hyun-Ki Kim, Hwaseong-si (KR)

Correspondence Address: STEIN, MCEWEN & BUI, LLP, 1400 EYE STREET, NW, SUITE 300, WASHINGTON, DC, 20005, US

(21) Appl. No.: 10/587,570

(22) PCT Filed: Mar. 15, 2005
(86) PCT No.: PCT/KR05/00739

§ 371 Date: Jul. 31, 2006

(30) Foreign Application Priority Data
Mar. 15, 2004 (KR) 10-2004-0017255

(51) Int. Cl. G11B 7/12

(52) U.S. Cl. 369/47.5; 369/275.3

(57) ABSTRACT

A hybrid information storage medium includes a lead-in area storing basic information regarding the information storage medium, a lead-out area indicating an end of the information storage medium, and a plurality of types of data areas requiring different optimal read powers, wherein different optimal read power information respectively specifying the different optimal read powers for the plurality of types of data areas are recorded on the information recording medium. Optimal read power information for each of a plurality of data areas of a hybrid super-resolution optical disk requiring different optimal read powers is provided to an optical disk drive when the optical disk drive reproduces data from the hybrid super-resolution optical disk so that optimal reproduction characteristics can always reliably be obtained.

### CROSS-REFERENCE TO RELATED APPLICATIONS

This application is the U.S. National Stage of International Application No. PCT/KR2005/000739 filed on Mar. 15, 2005, and claims the benefit of Korean Application No. 2004-17255 filed on Mar. 15, 2004, in the Korean Intellectual Property Office. The disclosures of International Application No. PCT/KR2005/000739 and Korean Application No. 2004-17255 are incorporated herein by reference in their entirety.

### BACKGROUND OF THE INVENTION

1. Field of the Invention

The invention relates to an information storage medium storing different read power information, and more particularly to a hybrid information storage medium including a plurality of types of data areas requiring different read powers, wherein different read power information respectively specifying the different read powers for the plurality of types of data areas are recorded on the hybrid information storage medium.

2. Description of the Related Art

Optical information storage media such as optical disks are widely used with optical pickups that record/reproduce information in a contact-free way. Such optical disks are divided into compact disks (CDs) and digital versatile disks (DVDs) according to their recording capacities, with DVDs having a higher recording capacity than CDs. In addition, high-density optical disks (generally, HD DVDs) having a higher recording capacity than DVDs, for example, a recording capacity of 20 GB or more, have been developed. When the capacity of an optical information storage medium increases, a length and a width of a pit formed on a read-only information storage medium decreases. This causes a signal reproduced from a minimum-size recording mark to become very small, thereby causing general reproduction characteristics to deteriorate.

To overcome this problem, a super-resolution optical disk has been proposed. The super-resolution optical disk is an optical recording medium using a super-resolution effect in which recording marks smaller than a readout resolution limit of a laser beam can be reproduced. This enables the super-resolution optical disk to remarkably satisfy a demand for a high-density, high-capacity optical recording medium.

As with other optical recording media, there are two types of super-resolution optical disks-a read-only disk and a writable disk. In addition, another type of super-resolution optical disk is a hybrid disk that includes both a read-only area and a writable area. When a hybrid super-resolution optical disk is used, for example, to distribute a game program, the game program is recorded in the read-only area of the hybrid super-resolution optical disk. If the game program is later upgraded, a user can download the upgraded game program from a distributor's web site to the writable area of the hybrid super-resolution optical disk. FIGS. 1B and 1C illustrate examples of an internal layer structure of such a hybrid super-resolution optical disk. The hybrid super-resolution optical disk may have a 5-layer structure, as shown in FIG. 1B, or a 7-layer structure, as shown in FIG. 1C. The hybrid super-resolution optical disk may have the same layer structure throughout its entire area, or may have different layer structures in the read-only area and the writable area. Referring to FIG. 1A, the read-only area may be placed in an outer region 10 of the hybrid super-resolution optical disk, and the writable area may be placed in an inner region 20 of the disk. Conversely, the writable area may be placed in the outer region 10 of the disk and the read-only area may be placed in the inner region 20 of the disk.

A super-resolution optical disk enabling marks smaller than a readout resolution limit of a laser beam to be reproduced uses a much greater read power than normal optical disks and has different reproduction characteristics that greatly depend on the read power. Accordingly, to reliably reproduce data from the super-resolution optical disk, an optimal read power must be used. For a conventional super-resolution optical disk, a read power dependency of a read-only area is different from a read power dependency of a writable area. In contrast, for a conventional normal optical disk, a writable area and a read-only area have the same read power dependency, and thus the same read power is used during reproduction of a hybrid conventional normal optical disk including both a read-only area and a writable area. A conventional hybrid super-resolution optical disk may have areas having different read power dependencies, for example, a read-only area and a writable area, or a super-resolution disk area and a normal disk area. Accordingly, to reliably reproduce data from such a conventional hybrid super-resolution optical disk with a disk drive, it is necessary to provide optimal read power information for each type of area of the disk to the disk drive, and to control a read power of the disk drive in accordance with the optimal read power information to achieve optimal reproduction characteristics for each type of area of the disk. To make it possible to satisfy these requirements, it would be desirable to record optimal read power information for each type of area of an information storage medium having a different read power dependency in a particular portion of the information storage medium.

### SUMMARY OF THE INVENTION

According to an aspect of the invention, there is provided a method for reliably reproducing data from a super-resolution optical disk including a plurality of types of data areas requiring different optimal read powers by providing optimal read power information to an optical disk drive that reproduces the super-resolution optical disk.

According to another aspect of the invention, an information storage medium has optimal read power information recorded in at least one of a lead-in area and a lead-out area of the information storage medium.

According to another aspect of the invention, a super-resolution optical disk drive controls a read power of the super-resolution optical disk drive according to read power information recorded on an information storage medium.

According to another aspect of the invention, a hybrid information storage medium includes a lead-in area storing basic information regarding the information storage medium, a lead-out area indicating an end of the information storage medium, and a plurality of types of data areas requiring different optimal read powers, wherein different optimal read power information respectively specifying the different optimal read powers for the plurality of types of data areas are recorded on the information storage medium.

The different optimal read power information may be recorded in the lead-in area and/or the lead-out area. The lead-in area may include a control data zone, the control data zone may include a plurality of reserved fields, and the different optimal read power information may be respectively recorded in arbitrary ones of the reserved fields of the control data zone.

According to another aspect of the invention, there is provided a method of recording/reproducing data on/from a hybrid information storage medium, the hybrid information storage medium including a plurality of types of data areas requiring different optimal read powers, the method including recording different optimal read power information respectively specifying the different optimal read powers for the plurality of types of data areas on the hybrid information storage medium, reading all of the different optimal read power information from the hybrid information storage medium, and reproducing data from any type of the plurality of types of data areas using a respective one of the different optimal read powers specified by a respective one of the different optimal read power information corresponding to a type of a data area from which data is to be reproduced.

The hybrid information storage medium may include a lead-in area and a lead-out area, and the different optimal read power information may be recorded in the lead-in area and/or the lead-out area.

The reproducing of data may include determining a type of a data area from which data is to be reproduced, controlling an output power of a laser diode to be a respective one of the different optimal read powers specified by a respective one of the different optimal read power information corresponding to the type of the data area from which data is to be reproduced, and reproducing data from the data area from which data is to be reproduced using a light beam emitted from the laser diode.

According to another aspect of the invention, an information storage medium includes a plurality of types of data areas requiring different optimal read powers, wherein different optimal read power information respectively specifying the different optimal read powers for the plurality of types of data areas are recorded on the information storage medium.

According to another aspect of the invention, there is provided an apparatus that reproduces data from an information storage medium, the information storage medium including a plurality of types of data areas requiring different optimal read powers, the information storage medium having recorded thereon different optimal read power information respectively specifying the different optimal read powers for the plurality of types of data areas, the apparatus including a pickup unit that emits a light beam onto the information storage medium during a data reproducing operation of the apparatus, receives a reflected light beam from the information storage medium, and outputs the reflected light beam, the reflected light beam being produced by the information storage medium reflecting the light beam emitted from the pickup unit, the pickup unit receiving a control signal that controls a read power of the light beam during the data reproducing operation; a signal processing unit that that receives the reflected light beam from the pickup unit, detects a data reproduction signal from the reflected light beam, and outputs the data reproduction signal, the data reproduction signal including the different optimal read power information recorded on the information storage medium; and a control unit that receives the data reproduction signal from the signal processing unit, stores the different optimal read power information included in the data reproduction signal, generates a control signal to control the read power of the light beam emitted from the pickup unit to be a respective one of the different optimal read powers specified by a respective one of the different optimal read power information corresponding to a type of a data area of the information storage medium from data is to be reproduced, and outputs the control signal to the pickup unit.

According to another aspect of the invention, optimal read power information for each of a plurality of types of data areas of a hybrid super-resolution optical disk requiring different optimal read powers is provided to an optical disk drive when the optical disk drive reproduces data from the hybrid super-resolution optical disk so that optimal reproduction characteristics can always reliably be obtained.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of embodiments of the invention, taken in conjunction with the accompanying drawings of which:

FIGS. 1A through 1C show a hybrid super-resolution optical disk used in the invention and examples of its internal layer structure;

FIG. 2 is a graph comparing read power characteristics of a read-only area and a writable area of a hybrid super-resolution optical disk;

FIG. 3 shows a structure of a normal data area of a disk;

FIG. 4 shows a data structure in a lead-in area of a disk;

FIG. 5 shows a method of recording read power information according to an embodiment of the invention; and

FIG. 6 is a schematic diagram of a recording/reproducing system for recording/reproducing information on/from an information storage medium according to an embodiment of the invention.

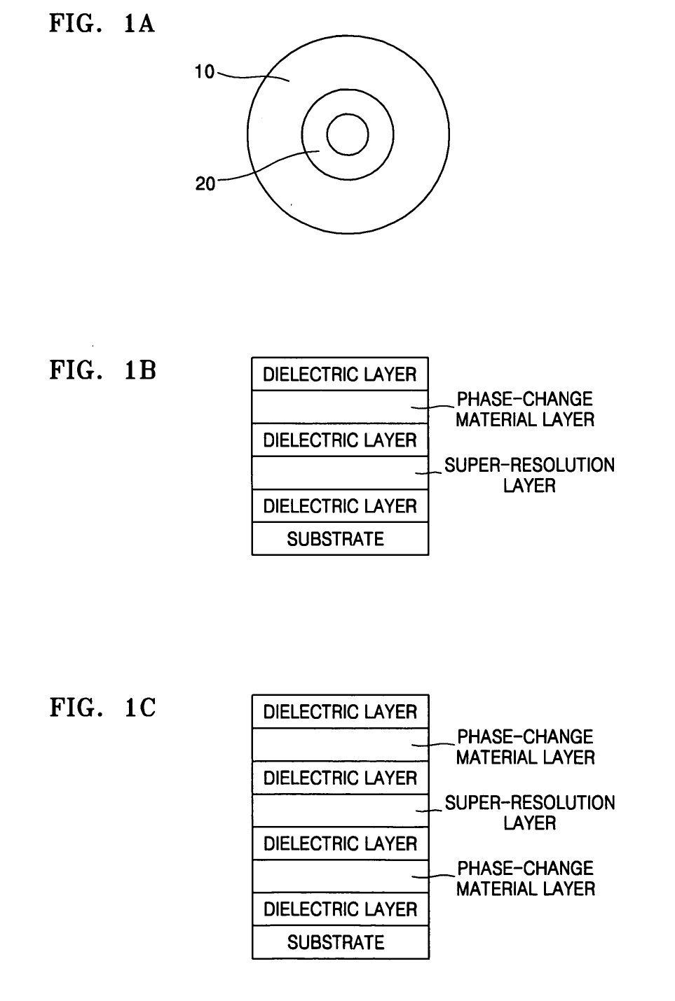

### DETAILED DESCRIPTION OF THE EMBODIMENTS

Reference will now be made in detail to embodiments of the invention, examples of which are illustrated in the accompanying drawings, wherein like reference numerals refer to like elements throughout. The embodiments are described below in order to explain the invention by referring to the figures.

As described above, since a super-resolution optical disk has reproduction characteristics that greatly depend on a read power, use of an optimal read power is required to reliably reproduce data from the super-resolution optical disk. Accordingly, if data is reproduced from a hybrid super-resolution optical disk using a single fixed read power, the data may not be reliably reproduced. In contrast, a conventional normal hybrid phase-change optical disk has reproduction characteristics that do not greatly depend on a read power. Accordingly, even if a single fixed read power is used for reproducing data throughout such a disk, the data can be reliably reproduced. However, for a hybrid super-resolution optical disk including a read-only area and a writable area requiring respective different optimal read powers, it is necessary to use the respective different optimal read powers when reproducing data from the read-only area and when reproducing data from the writable area to reliably reproduce the data.

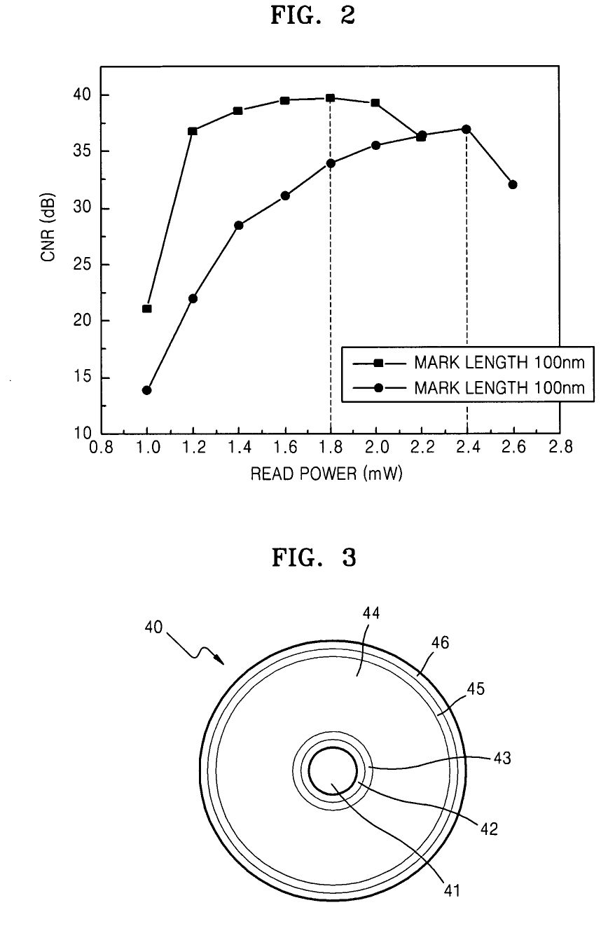

FIG. 2 is a graph comparing read power characteristics of a read-only area and a writable area of a hybrid super-resolution optical disk having a 5-layer structure. As shown in FIG. 2, in the writable area (i.e., a write-once-read-many (WORM) type area) having a 100-nm recording mark, a maximum carrier-to-noise ratio (CNR) of 40 dB was measured at a read power of about 1.8 mW. Thus, an optimal read power for the writable area was 1.8 mW. In the read-only area (i.e., a read-only memory (ROM) type area) having the same 100-nm recording mark, a maximum CNR of 37 dB was measured at a read power of about 2.4 mW. Thus, an optimal read power for the read-only area was 2.4 mW. Consequently, the hybrid super-resolution optical disk with the 5-layer structure had a difference of about 0.6 mW between the optimal read power of 2.4 mW for the read-only area and the optimal read power of 1.8 mW for the writable area. This result implies that respective different read powers are needed when a super-resolution disk drive reads data from the read-only area and the writable area to reliably reproduce the data. Accordingly, optimal read power information for each type of area of the hybrid super-resolution optical disk needs to be provided to the disk drive.

An aspect of the invention enables read power information to be recorded in a particular portion of a hybrid super-resolution optical disk, and enables a disk drive to read the read power information from the disk before reproducing data from the disk. For this operation, an appropriate portion of the disk in which read power information for each type of area is recorded needs to be defined.

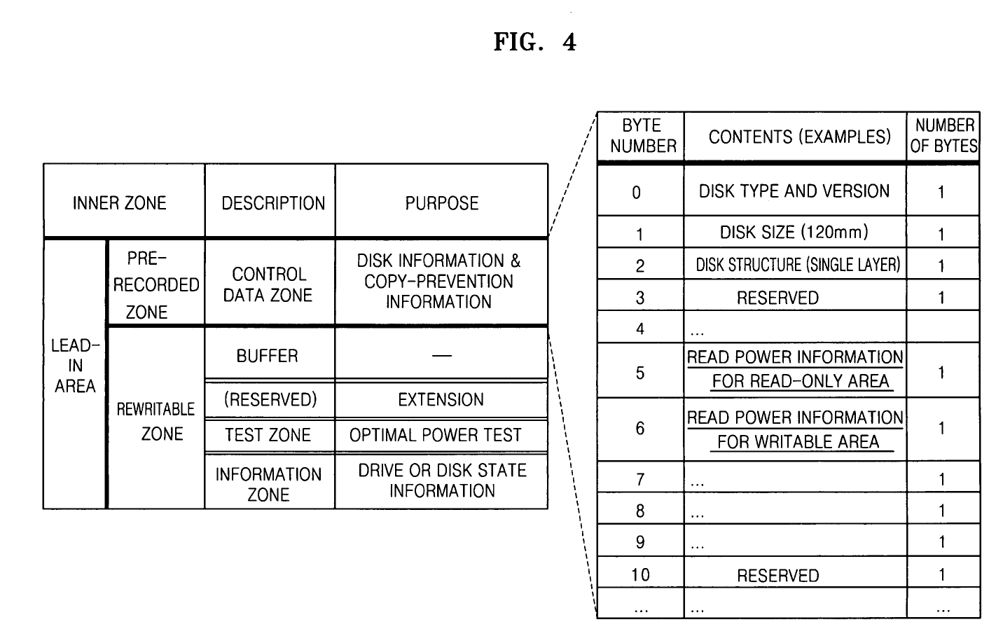

FIG. 3 shows a conventional structure of an optical disk 40. A through-hole 41 is formed at a center of the optical disk 40 to enable the optical disk to be mounted on a central shaft of a turntable within a disk drive by putting the through-hole 41 around the central shaft. A clamping area 42 for use in clamping the optical disk 40 to the turntable and having a predetermined width is formed concentrically around the through-hole 41. No data is stored in the clamping area 42. A lead-in area 43 for storing information regarding the optical disk 40, such as a start position of data on the optical disk 40 and a name of the optical disk 40, and information regarding data recorded on the optical disk 40, is formed around the clamping area 42. A recording area 44 for storing user data is formed around the lead-in area 43. If the optical disk 40 is a hybrid super-resolution optical disk, the recording area 44 includes a read-only area and a writable area. A lead-out area 45 indicating an end of the optical disk 40 is formed around the recording area 44. A no-data area 46 in which no data is recorded is formed around the lead-out area 45 to enable a user to hold the optical disk by the no-data area 46. The lead-in area 43, the recording area 44, and the lead-out area 45 constitute a data area of the optical disk 40

In embodiments of the invention, read power information may be recorded in the lead-in area 43 located at an innermost circumference of the data area of the optical disk 40 and/or in the lead-out area 45 located at an outermost circumference of the data area of the optical disk 40. The read power information may be recorded only in the lead-in area 43 or only in the lead-out area 45, or may be recorded in both the lead-in area 43 and the lead-out area 45 for increased reliability. It is preferable to record the read power information on a substrate of the optical disk 40 as prepits or wobble grooves to prevent the read power information from being changed when a user records data on the optical disk 40. It is most preferable to record the read power information in a control data zone within the lead-in area 43 as described below.

FIG. 4 shows a conventional data format in a lead-in area on a disk. The lead-in area mainly includes a prerecorded zone, in which data is recorded during manufacturing of the disk and is not changed thereafter, and a rewritable zone, which changes when a user records data on the disk. A control data zone corresponds to the prerecorded zone and stores information regarding the disk (hereinafter referred to as “disk information”) and information for copy prevention (hereinafter referred to as “copy-prevention information”). In addition, the control data zone includes a plurality of data fields for storing various types of information including a disk type. Some of these data fields are reserved fields in which no information is recorded during manufacturing of the disk so that information can be additionally recorded therein according to a manufacturer's necessity thereafter. In embodiments of the invention, different read power information are recorded in arbitrary ones of the reserved fields such that read power information for a read-only area is recorded in a particular one of the reserved fields and read power information for a writable area is recorded in another particular one of the reserved fields. For example, referring to FIG. 4, the read power information for the read-only area is recorded in byte number 5 of the control data zone constituting one of the reserved fields, and the read power information for the writable area is recorded in byte number 6 of the control data zone constituting another one of the reserved fields.

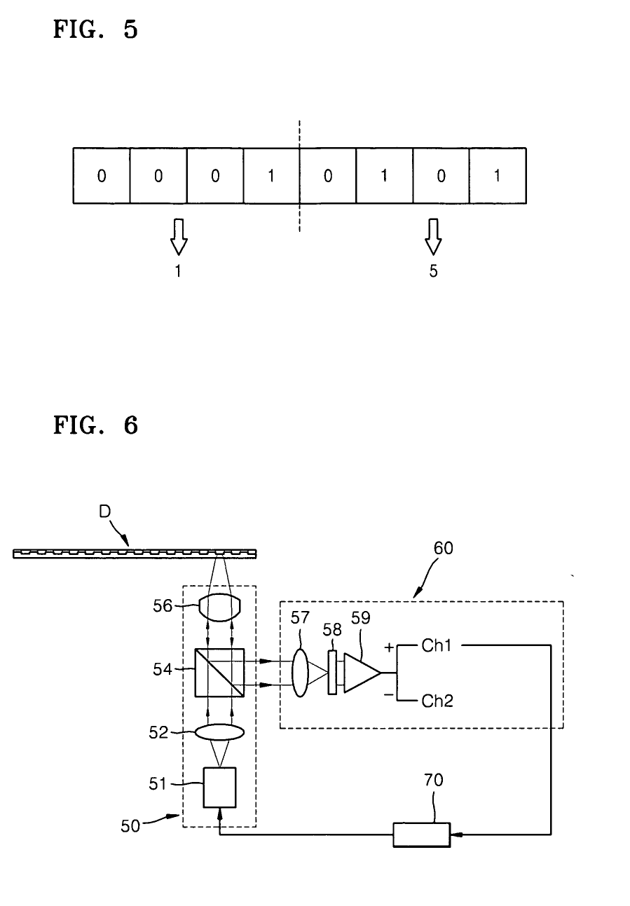

If the read power information is recorded according to a predetermined rule, it will be more reliable and convenient to use. For example, the read power information for a particular area may be recorded in a one-byte field constituted by eight bits using the following method. As shown in FIG. 5, the four most significant bits (MSBs) of the eight bits may be used to express an integer part of the read power information, and the four least significant bits (LSBs) of the eight bits may be used to express a fraction part of the read power information. For example, when an optimal read power is 1.5 mW, the four MSBs may be “0001”, indicating “1”, and the four LSBs may be “0101”, indicating “5”. Then, when an optical disk drive reads the eight bits and interprets the eight bits according to this predetermined rule, it can detect that the optimal read power is 1.5 mW. However, the above-described method of recording the read power information is just an example, and various other recording methods may be used in the invention.

The above-described principle of the invention can also be applied when there are two or more read-only areas or two or more writable areas. In addition, although the above description has mainly referred to a hybrid optical disk including a read-only area and a writable area, the principle of the invention can also be applied to any type of optical disk that includes a plurality of types of data areas requiring different read powers, such as a super-resolution disk area and a normal disk area.

Now, a recording/reproducing system, e.g., an optical disk drive, that records/reproduces data on/from a super-resolution optical disk storing different read power information according to an embodiment of the invention will be described with reference to FIG. 6.

FIG. 6 is a schematic diagram of a recording/reproducing system which records/reproduces data on/from an information storage medium on which different read power information has been recorded according to an embodiment of the invention. The recording/reproducing system includes a pickup unit 50, a recording/reproducing signal processing unit 60, and a control unit 70. The pickup unit 50 includes a laser diode 51 that emits light, a collimating lens 52 that collimates the light emitted from the laser diode 51, a beam splitter 54 through which the collimated light from the collimating lens 52 passes unchanged, and an objective lens 56 that focuses the light passing through the beam splitter 54 onto an information storage medium D.

Light reflected from the information storage medium D is collected by the objective lens 56 and reflected by the beam splitter 54 onto a lens 57 that focuses the light from the beam splitter 54 onto a photodetector 58 having four divisions as known in the art. The photodetector 58 converts the light from the lens 57 into electrical signals corresponding to the four divisions of the photodetector 58 as known in the art. An operation circuit 59 receives the electrical signals from the photodetector 58 and outputs electrical signals to a first channel Ch1 that detects a sum signal constituting a data reproduction signal as known in the art, and to a second channel Ch2 that detects a signal by a push-pull method as known in the art.

The recording/reproducing system shown in FIG. 6 having the above-described structure is designed so that the pickup unit 50 emits a recording beam having a power higher than a predetermined value (e.g., 10 mW) under control of the control unit 70 so that recording marks having a size (e.g., 100 nm) smaller than a recording resolution limit of the recording beam can be formed when the recording/reproducing system records data on the information storage medium D.

The following description concerns a process in which data is reproduced from a hybrid information storage medium storing different read power information according to an embodiment of the invention. When the hybrid information storage medium is inserted into the recording/reproducing system shown in FIG. 6, the recording/reproducing system reads a lead-in area of the hybrid information storage medium to obtain information regarding the hybrid information storage medium itself and information regarding data recorded on the hybrid information storage medium. Optimal read power information for a read-only area of the hybrid information storage medium and optimal read power information for a writable area of the hybrid information storage medium that have been recorded in the lead-in area as described above can be obtained when the lead-in area is read. Alternatively, if the optimal read power information has been recorded in a lead-out area of the hybrid information storage medium as described above, the recording/reproducing system reads the lead-out area to obtain the optimal read power information.

The obtained optimal read power information for the read-only area and the writable area is contained in the sum signal constituting a data reproduction signal that is detected by the first channel Ch1 shown in FIG. 6, and is input to the control unit 70 where the obtained optimal power information is stored in a memory (not shown) in the control unit 70. Thereafter, when the recording/reproducing system reproduces data from the read-only area of the hybrid information storage medium, the control unit 70 controls an output of the laser diode 51 in accordance with the optimal read power information for the read-only area stored in the memory. Similarly, when the recording/reproducing system reproduces data from the writable area of the hybrid information storage medium, the control unit 70 controls the output of the laser diode 51 in accordance with the optimal read power information for the writable area stored in the memory. As a result, the recording/reproducing system can optimally reproduce data from any area of the hybrid information storage medium.

Although several embodiments of the invention have been shown and described, it would be appreciated by those skilled in the art that changes may be made in these embodiments without departing from the principles and spirit of the invention, the scope of which is defined in the claims and their equivalents.

1. An information storage medium comprising:
a lead-in area storing basic information regarding the information storage medium;
a lead-out area indicating an end of the information storage medium; and
a plurality of types of data areas requiring different optimal read powers;
wherein different optimal read power information respectively specifying the different optimal read powers for the plurality of types of data areas are recorded on the information storage medium.

2. The information storage medium of claim 1, wherein the different optimal read power information are recorded in the lead-in area and and/or the lead-out area.

3. The information storage medium of claim 2, wherein the lead-in area comprises a control data zone;
wherein the control data zone comprises a plurality of reserved fields; and
wherein the different optimal read power information are respectively recorded in arbitrary ones of the reserved fields of the control data zone.

4. The information storage medium of claim 1, wherein the different optimal read power information are respectively recorded in one-byte units;
wherein each of the one-byte units comprises eight bits;
wherein four most significant bits of the eight bits of each of the one-byte units express an integer part of a respective one of the different optimal read powers specified by a respective one of the different optimal read power information recorded in the one-byte unit; and
wherein four least significant bits of the eight bits of each of the one-byte units express a fraction part of a respective one of the different optimal read powers specified by a respective one of the different optimal read power information recorded in the one-byte unit.

5. The information storage medium of claim 1, wherein the different optimal read power information are recorded as prepits or wobble grooves to prevent the different optimal read power information from being changed when user data is recorded on the information storage medium.

6. The information storage medium of claim 1, wherein the plurality of types of data areas comprise a super-resolution area on/from which information is recorded/reproduced using a super-resolution effect.

7. A method of recording/reproducing data on/from a hybrid information storage medium, the hybrid information storage medium comprising a plurality of types of data areas requiring different optimal read powers, the method comprising:
recording different optimal read power information respectively specifying the different optimal read powers for the plurality of types of data areas on the hybrid information storage medium;
reading all of the different optimal read power information from the hybrid information storage medium; and
reproducing data from any type of the plurality of types of data areas using a respective one of the different optimal read powers specified by a respective one of the different optimal read power information corresponding to a type of a data area from which data is to be reproduced.

8. The method of claim 7, wherein the hybrid information storage medium comprises a lead-in area and a lead-out area: and
wherein the different optimal read power information are recorded in the lead-in area and/or the lead-out area.

9. The method of claim 7, wherein the reproducing of data comprises:
determining a type of a data area from which data is to be reproduced;
controlling an output power of a laser diode to be a respective one of the different optimal read powers specified by a respective one of the different optimal read power information corresponding to the type of the data area from which data is to be reproduced; and
reproducing data from the data area from which data is to be reproduced using a light beam emitted from the laser diode.

10. An apparatus that reproduces data from an information storage medium, the information storage medium comprising a plurality of types of data areas requiring different optimal read powers, the information storage medium having recorded thereon different optimal read power information respectively specifying the different optimal read powers for the plurality of types of data areas, the apparatus comprising:
a pickup unit that emits a light beam onto the information storage medium during a data reproducing operation of the apparatus, receives a reflected light beam from the information storage medium, and outputs the reflected light beam, the reflected light beam being produced by the information storage medium reflecting the light beam emitted from the pickup unit, the pickup unit receiving a control signal that controls a read power of the light beam during the data reproducing operation;
a signal processing unit that that receives the reflected light beam from the pickup unit, detects a data reproduction signal from the reflected light beam, and outputs the data reproduction signal, the data reproduction signal including the different optimal read power information recorded on the information storage medium; and
a control unit that receives the data reproduction signal from the signal processing unit, stores the different optimal read power information included in the data reproduction signal, generates a control signal to control the read power of the light beam emitted from the pickup unit to be a respective one of the different optimal read powers specified by a respective one of the different optimal read power information corresponding to a type of a data area of the information storage medium from data is to be reproduced, and outputs the control signal to the pickup unit.

11. The apparatus of claim 10, wherein the plurality of types of data areas of the information storage medium comprise a read-only data area and a writable data area.

12. The apparatus of claim 11, wherein the information storage medium is a super-resolution information storage medium from which data is reproduced using a super-resolution effect.

13. The apparatus of claim 10, wherein the plurality of types of data areas comprise a super-resolution data area from which data is reproduced using a super-resolution effect, and a normal data area from which data is reproduced without using the super-resolution effect.

14. The apparatus of claim 10, wherein the information storage medium further comprises a lead-in area and a lead-out area; and
wherein the different optimal read power information are recorded in the lead-in area and/or the lead-out area.
